(19) United States
(12) Patent Application Publication
(10) Pub. No.: US 2026/0109579 A1
(43) Pub. Date: Apr. 23, 2026

(54) METHOD FOR LOADING A TRANSPORT MEANS WITH A LOADING CONTAINER, HANDLING DEVICE

(71) Applicant: Siemens Aktiengesellschaft, München (DE)

(72) Inventors: Matthias Bachhuber, Regensburg (DE); Florian Meser, Erlangen (DE); Jörn Rechenburg, Schwaig (DE); Tommaso Cinotti, Erlangen (DE); Kevin Haybach, Forchheim (DE); Jahanbaz Khan, Erlangen (DE)

(21) Appl. No.: 18/720,654

(22) PCT Filed: Apr. 7, 2022
(86) PCT No.: PCT/EP2022/059232

§ 371 Date: Jun. 16, 2024

(30) Foreign Application Priority Data
Dec. 17, 2021 (EP) 21215669.9

(51) Int. Cl. B66C 13/48; B66C 13/08; G01S 17/42; G01S 17/89; G06T 7/73; G06V 10/25; G06V 10/26; G06V 10/44; G06V 10/764; G06V 20/50

(52) U.S. Cl. CPC B66C 13/48; B66C 13/085; G01S 17/42; G01S 17/89; G06T 7/73; G06V 10/25; G06V 10/26; G06V 10/44; G06V 10/764; G06V 20/50; G06T 2207/10028; G06V 2201/07

(57) ABSTRACT

The invention relates to a method (PRC) for loading a transport means (TPT) with a loading container (CNT). To automate the handling process by means of a handling device, is it proposed: a) defining a spatially fixed coordinate system (MCS), the first and second coordinate directions of which (COX, COY) are located substantially in a horizontal plane (PLN) and the third coordinate direction (COZ) of which extends substantially vertically in the height direction (HDR), b) receiving a surface geometry (SGT) in the region of a handling region (TOA), c) identifying a region of a transport means (TPT), d) determining the location of a loading surface of the transport means (TPT), e) determining a spacial angular position of a loading surface of the transport means (TPT), f) identifying and classifying one or more determined loading surfaces (LDR) of the transport means (TPT), g) identifying fastening elements (TWL) and/or guide elements (GDE) and/or obstacles (OBT) and/or loads (LOD) on the loading surface (LDR), h) choosing a loading container (CNT) that fits a determined loading surface (LDR) and the associated fastening elements (TWL) of the transport means (TRT), i) loading the loading surface (LDR) of the transport means (TRT) with the chosen loading container (CNT).

The invention relates to a method for detecting a loading surface of a transport means for automated loading with a loading container.

Handling or transshipment is one of the three main processes (TUL processes) in logistics in addition to storage and transport. Handling is a process in which goods change transport means, i.e., for example, are transferred from a truck onto a ship or train. The terms loading and unloading are sometimes used synonymously with handling, and sometimes they stand for transferring.

In container terminals, customer requirements for the purchasing or modernization of cranes increasingly trend toward “fully automated cranes”. These are intended to operate without the additional interventions of remote operators or crane drivers. There is strong competition between the providers in this technical field. Corresponding automation systems are crucial for the economic success of handling devices, particularly in the case of large projects. Equally, there is a very high demand for sensor systems which assist the automatic picking up and setting down of loading containers on trucks.

One example of a loading situation is:
a tractor with an empty trailer moves under the crane. For an automatic transfer of a container, it has to be known where a free loading surface of the trailer is located.
A loaded trailer moves under the crane. For an automatic transfer of a loading container, it has to be known where loading containers to be unloaded are located. Furthermore, it has to be known whether a further loading surface in addition to the already loaded trailer is also free in order optionally to place a further container on the trailer.

Previous solutions are based on the explicit knowledge of the trailers which can be handled in a container terminal. That is to say that only a certain number of tractors and container semitrailers that the truck positioning system has to know in advance can be dealt with. This does not permit handling of road trailers since these have a high number of variants and each variant may decisively differ. In addition, time-consuming manual measurement and parameterization when commissioning these semitrailers are necessary and these then have to be added by customers to their own system database. This involves the following disadvantages:
conventional systems are inflexible. As soon as a new type of trailer moves under the crane, said trailer cannot be supported,
corresponding systems generally do not operate on the basis of a set of rules which describes how a trailer has to be designed since there is no corresponding valid standard. Therefore, with a system which is based on the fact that transport means are known beforehand, autonomous transfer is not successful in practice,
conventional systems have a high outlay on commissioning because all of the trailers first of all have to be measured and parameterized before the system can deal with them; the same applies for maintenance because the customer has to record new transport means anew in order to be able to deal with them,
conventional systems have a high susceptibility to faults as a consequence of the risk of confusion in cases where a new type of trailer very closely resembles an old type of trailer,
a conventional handling system can therefore be provided by the manufacturer only if all of the transport means to be supported are known.

On the basis of the problems from the prior art, it is the object of the invention to develop a method and a handling device of the type defined at the beginning in such a manner that the disadvantages mentioned are avoided.

The invention refers to containers below as loading containers.

To achieve the object according to the invention, a method of the type defined at the beginning with the additional features of the characterizing part of independent claim 1 is proposed. In addition, the invention proposes a handling device for carrying out the method according to the device claim. The dependent claims in each case comprise advantageous developments of the invention.

The invention relates to a method for detecting a loading surface of a transport means for automated loading with a loading container.

The invention also relates to a method for loading a transport means with a loading container, comprising the method for detecting a loading surface of a transport means also in respect of all of the developments mentioned.

Furthermore, the invention also relates to a method for generating instructions for a transfer device or handling device, in particular a crane, for positioning a loading container on the loading surface of a transport means, comprising the method for loading a transport means with a loading container also in respect of all of the developments mentioned.

Some of the fundamental problems identified by the invention reside in:
the classifying and locating of a suitable loading surface,
the locating of suitable features on the loading surface that predefine possible positions for a loading container,
determining a rotation of the truck about the lifting mechanism axis of the crane (what is referred to as skew) so that the rotation of the load picking-up means can be adapted. The fundamental problem therein is highly accurately and reliably determining the rotation of the loading surface. The boundary conditions in that respect are that the density distribution of the underlying 3D point cloud is highly nonuniform. This is anti-proportional to the distance of the laser that is used for generating the point cloud. Furthermore, the determining of the rotation must not last longer than 500 milliseconds so that the automated sequence of the crane is not disturbed and can therefore be operated without process interruption.

In principle, the following steps are worked through according to the invention:
a) defining a spatially fixed coordinate system, the first and second coordinate directions of which are located substantially in a horizontal plane and the third coordinate direction of which extends substantially vertically in a height direction,
b) recording a surface geometry in the region of a handling region,
c) identifying a region of a transport means,
d) determining the location of a loading surface of the transport means,
e) determining a spatial angular position of a loading surface of the transport means,
f) identifying and classifying one or more determined loading surfaces of the transport means,
g) detecting fastening elements and/or guide elements and/or obstacles and/or loads on the loading surface.
h) selecting a loading container which is suitable for a determined loading surface and the associated fastening elements of the transport means,
i) loading the loading surface of the transport means with the selected loading container.

The surface geometry in the region of a handling region is particularly expediently recorded as a point cloud. For this purpose, the handling device has a scanner which is preferably designed as a laser scanner, by means of which the handling region is scanned point by point so that this point cloud can be made available to the processor of a control unit for further evaluation.

An advantageous development of the invention makes provision that, for identifying a region of the transport means, the method in each case optionally comprises the further steps in detail:
entering the point cloud of the surface geometry as an initial point cloud,
defining volumes of the initial point cloud, the volumes in each case extending next to one another in the manner of disks along the first horizontal coordinate directions with certain discretization width with respect to the first horizontal coordinate directions,
reducing the initial point cloud by the points of a number of outer volumes such that 30%-80%, preferably 45%-55%, particularly preferably 50%, of the overall width of the volumes remain,
defining the remaining volumes as a new point cloud.

In principle, the outer regions of the initial point cloud may also be removed without a previous disk-like division, with this discretization having proven particularly expedient. The removal of the outer region of the point cloud serves substantially for acceleration and avoiding of interfering influences. In addition, it is shown that these outer regions are not required in the first place for the purpose of identifying a region of a transport means.

An optional variant of the invention here makes provision that the determined discretization width is between 1 cm-1 m, preferably 5 cm-15 cm, particularly preferably 10 cm, and therefore details of the loading surface can be detected.

Furthermore, the susceptibility to fault of the method can be reduced if the method comprises the further steps of:
defining a range of valid height values for the third coordinate direction of the initial point cloud,
discarding the points in the volumes which exclusively have points with height values outside the range of valid height values,
defining these remaining points as a new point cloud which includes the transport means.

Expediently, the range of valid height values for the third coordinate direction can be between 20 cm-700 cm. Alternatively, the range of valid height values for the third coordinate direction can be between 20 cm-500 cm.

After these optional steps for reducing the susceptibility to fault, an advantageous variant of the method according to the invention provides the steps of a basic routine, wherein said basic routine is flexibly usable in different variants or by means of differing parameterization for the purposes of the invention and the developments thereof:
entering the point cloud of the surface geometry as an initial point cloud,
selecting a horizontal coordinate direction as a profile direction,
defining volumes of the initial point cloud, the volumes in each case extending next to one another in the manner of disks along the other horizontal coordinate directions, not selected, with a certain discretization width with respect to the profile direction,
generating a height profile in the profile direction from profile points, with a profile point being defined for each volume,
wherein the coordinate of the profile point in the profile direction is allocated as a coordinate value of the profile direction in each case to a determined position of the discretization width of the volume,
wherein said determined position for each volume is at the same point of the discretization width,
wherein the coordinate of the profile point in the height direction is allocated as a coordinate value of the highest value in each case present in the volume of the third coordinate direction of a point.

Advantageously, a development of the method makes provision that, for determining the ends of a transport means in the first horizontal coordinate direction, the following steps are additionally carried out:
entering the point cloud of the surface geometry as an initial point cloud,
defining volumes of the initial point cloud, the volumes in each case extending next to one another in the manner of disks along the second horizontal coordinate directions with a second discretization width of at least 15 ft, preferably at least 20 ft,
carrying out the steps according to the above basic routine for each individual point cloud of the point clouds arranged in each of the volumes, with the following stipulations:
   a. the second horizontal coordinate direction is the profile direction, thus resulting in a height profile extending along the second horizontal coordinate direction,
   b. wherein the determined discretization width is between 1 cm-1 m, preferably 5 cm-15 cm, particularly preferably 10 cm,
comparing the widest length of the height profile with respect to the second horizontal coordinate direction with a minimum value and discarding the points located in the respective volume if the widest length of the height profile lies below the minimum value,
defining the non-discarded portion of the initial point cloud as a new point cloud which comprises the transport means.

An additional advantageous development makes provision that the edges or ends of the transport means are identified by creating a profile of the transport means, by the method comprising the following:
carrying out the steps according to the above basic routine for the point cloud, with the following stipulations:
   a. the first horizontal coordinate direction is the profile direction, thus resulting in a height profile extending along the first horizontal coordinate direction,
   b. wherein the determined discretization width is between 1 cm-1 m, preferably 5 cm-15 cm, particularly preferably 10 cm,
dividing the profile into two-dimensional object profiles, wherein an object profile extends over a region of the first horizontal coordinate direction which exclusively has profile points with height values of the height profile of greater than 0,
combining object profiles which are at a distance of less than 3 m, in particular less than 1.5 m, from one another in the first horizontal coordinate direction to form in each case a common object profile, and therefore the transport means are in each case located in the resulting regions of the first horizontal coordinate direction of the common object profiles.

An additional advantageous development makes provision that, for identifying the loading surface of the transport means, the following steps are carried out:
carrying out the steps according to the above basic routine for the point cloud, with the following stipulations:
   a. the first horizontal coordinate direction is the profile direction, thus resulting in a height profile extending along the first horizontal coordinate direction,
   b. wherein the determined discretization width is between 1 cm-1 m, preferably 5 cm-15 cm, particularly preferably 10 cm,
dividing the height profile into segments by determining a segment by means of the stipulation that, in a step-by-step evaluation from point to point, the vertical distance from the previous point is less than 2 horizontal discretization widths,
defining the longest segment determined in this way as a preliminary estimation of the loading surface extent along the first horizontal coordinate direction.

Furthermore, a vertical offset 4 the loading surface can be determined, preferably at least preliminarily, from the value range of the third vertical coordinate direction of the estimation of the loading surface extent.

In order to determine an angular position of the loading surface of the transport means, an advantageous development of the invention provides the following further steps:
carrying out the steps according to the above basic routine for the point cloud, in particular for the point cloud exclusively in the region of the preliminary estimation of the loading surface extent as claimed in the preceding claim 11, with the following stipulations:
   a. the first horizontal coordinate direction is the profile direction, thus resulting in a height profile extending along the first horizontal coordinate direction,
   b. wherein the determined discretization width is between 1 cm-1 m, preferably 5 cm-15 cm, particularly preferably 10 cm,
dividing the height profile into segments by determining a segment by means of the stipulation that, in a step-by-step evaluation from point to point, the vertical distance from the previous point is less than half a horizontal discretization width,
defining the longest segment determined in this way,
determining an angle of inclination of the longest segment determined in this way as an angle of inclination of the loading surface.

For identifying edges on the determined loading surface of the transport means, an advantageous development of the invention provides the further steps of:
providing a grid consisting of individual grid elements of the region,
selecting those grid elements which contain points,
determining grid elements which comprise an edge of the transport means as edge grid elements,
sorting the edge grid elements according to the respective edge orientation on the basis of the spatial coordinate system into groups of edge grid elements containing edge points, wherein the groups comprise:
   falling edge points in the first horizontal coordinate direction,
   rising edge points in the first horizontal coordinate direction,
   falling edge points in the second horizontal coordinate direction,
   rising edge points in the second horizontal coordinate direction,
generating edge lines with reference to the edge points by multiple line segmentations for the respective groups. In the case of the line segmentation, a line is in each case placed through as many predefined surrounding volumes of edge points as possible and said edge points are replaced by the respective line.

In order to determine the inclination of edge lines in relation to the first horizontal coordinate direction, a preferred development of the method provides the additional steps of:
combining edge lines to form combined edge lines, those edge lines being combined which enclose the same angle in relation to the first horizontal coordinate direction apart from an angular deviation region,
determining a quality factor for the edge lines and/or combined edge lines, the quality factor being rising or proportionally rising with the number of edge points replaced by the edge line or the edge lines on which the combined edge line is based,
establishing a longitudinal axis of the transport means, the direction of those edge lines and/or combined edge lines which have an angular deviation from the first horizontal coordinate direction that is smaller than 10° and the quality factor of which is the highest compared to the others, being defined as the direction of the longitudinal axis,
determining a first offset angle between the first horizontal coordinate direction and the longitudinal axis of the transport means.

In order to identify and classify a determined loading surface of the transport means, it is expedient, according to an advantageous variant of the invention, to provide the following further steps:
on the basis of the spatially fixed coordinate system and using the angle of inclination and the first offset angle, defining a transport means coordinate system with a first substantially horizontal transport means coordinate direction (generally and preferably the vehicle longitudinal axis) along the longitudinal axis of the transport means, with a second substantially horizontal transport means coordinate direction (generally and preferably the vehicle transverse axis) transversely with respect to the first horizontal transport means coordinate direction, and with a third substantially vertical third transport means coordinate direction (generally and preferably the height direction) which is perpendicular to the other transport means coordinate directions,
defining a two-dimensional reference contour corresponding to a contact area of a loading container with respect to the transport means coordinate system,
identifying a level loading surface of a transport means to be loaded, preferably according to a method already explained above,
defining a two-dimensional loading surface contour as a projection in the direction of the third transport means coordinate direction of the level loading surface,
repeating a virtual test to superimpose the reference contour on a reference contour position with the loading surface contour in such a manner that certain criteria are met,
the certain criteria being:
   no edge of the reference contour is located outside the loading surface contour, and/or
   the reference contour is arranged completely in the loading surface contour, and/or
   there is no edge of the loading surface in the region of the overlapping of the reference contour with the loading surface contour,
   wherein the reference contour positions which meet the certain criteria are classified as valid reference contour positions,
   wherein, during each repetition, the reference contour is moved to a different reference contour position with a predefined step width with respect to the loading surface contour in the first transport means coordinate direction, wherein the test is repeated until the reference contour has passed through the test contour along all possible steps in the first transport means coordinate direction,
wherein, during each repetition, the reference contour is moved with a predefined step width with respect to the test contour in the second transport means coordinate direction, wherein the test is repeated until the reference contour has passed through the test contour along all possible steps along the second transport means coordinate direction and until the reference contour has passed through the test contour along all possible steps along the first transport means coordinate direction,
wherein mutually overlapping reference contours at valid reference contour positions are joined together to form a common valid loading surface.

Basically-reproduced in other words in simplified form-in this case a 2D reference contour attempts to place in particular an ISO surface (e.g. an ISO 20 ft surface—https://de.wikipedia.org/wiki/ISO-Ladebehülter) virtually on the loading surface of the transport means. If the intersecting surface between the virtual ISO 20 ft loading container surface and the surface of the loading container semitrailer satisfies certain criteria here (e.g. “no edge hangs in the air”, “there is no obstacle such as side boundaries in the rectangle or the loading container base area”), this test is assessed as being “valid”. This test is carried out step-by-step for all of the possible positions of the loading container base area on the loading surface of the transport means. A fusion of all of the valid tests finally describes a continuous loading surface available for a loading container.

An advantageous development of the method according to the invention makes provision that a loaded transport means is identified by a determined, already identified loading surface of a transport means being classified as a loaded loading surface if the points of the loading surface lie in a vertical coordinate direction in the region of an anticipated height of a loading container roof.

An additional advantageous development of the invention for detecting fastening elements comprises the following steps after the identification of a loading surface:
selecting those points of the point cloud in the horizontal region of the identified loading surface which, with respect to a predefined surrounding volume, have a local maximum value of the third coordinate direction as potential fastening element positions,
defining predefined patterns of horizontal arrangements of fastening elements,
comparing the patterns with the potential fastening element positions to determine a best correspondence, wherein those potential fastening element positions without a correspondence to an element of a pattern are discarded and those with a correspondence are established as fastening element positions.

Branch know-how can be used in the definition of patterns of horizontal arrangements of fastening elements. Loading containers are fastened on a trailer by four fastening elements or what are referred to as twistlocks. This involves a respective twistlock at each lower corner of the loading container. It should also be noted that the width of loading container is standardized (https://de.wikipedia.org/wiki/ISO-Container) and, in the case of the most common loading containers, is even always identical.

An alternative variant of the previously described advantageous development of the invention for detecting fastening elements is provided by the sequence of the steps after the identification of a loading surface:
1. defining two-dimensional reference contours corresponding to contact areas of loading containers,
2. defining fastening reference contours corresponding to fastening devices of loading containers,
3. determining local maxima of the surface geometry in the vertical coordinate direction in the region of the identified loading surface,
4. determining regions of the fastening reference contours in which local maxima of the surface geometry resulting through fastening means are arranged in the vertical coordinate direction for each fastening reference contour as a pattern template for local maxima,
5. comparing the local maxima of the surface geometry with the pattern template of the fastening reference contours, wherein the fastening reference contour selected as the pattern identified here is that in the regions of which, for local maxima of the pattern template, all of the local maxima have a correspondence of a local maximum of the surface geometry and in which there is a maximum number of local maxima of the pattern template.

An advantageous development of the invention provides steps for identifying and classifying a determined loading surface of the transport means by means of fastening means. In detail, the following steps are provided-also in a sequence other than that listed here:
identifying a loading surface according to the method steps already described above,
detecting and differentiating elements on the loading surface, in particular predetermined fastening means,
differentiating between loading surfaces of unloaded transport means and loading surfaces loaded with loading containers of transport means.

An advantageous refinement of this procedure makes provision, for detecting and differentiating determined fastening means, for the following steps:
identifying points vertically above the loading surface with respect to the third transport means coordination direction,
determining local maxima of the surface geometry in the vertical coordinate direction in the region of the identified loading surface.

A further advantageous developing variant of the invention for detecting and differentiating elements on the loading surface is provided by an element detection method which is applied to a point cloud, which is generated by means of a scan or laser scan, of an unloaded transport means, in particular of a predetermined type, in order to find elements (i.e. three-dimensional objects, fastening elements, obstacles, guide elements) which are relevant for determining the precise loading region or the loading surface, i.e. for determining a precise possible position of a loading container on the loading surface of the transport means. For this purpose, the following steps are carried out:
1. identifying a level loading surface in the scanned point cloud,
2. detecting all of the points vertically above the loading surface,
3. dividing the detected points vertically above the loading surface into different elements,
4. creating a geometrical model for the different elements for further assessment or classification of the elements.

In practice, during the identification of a level loading surface in the scanned point cloud, the following problems arise:
1. the plane of the loading surface is rotated out of the horizontal position of an unknown roll, pitch and yaw angle,
2. the point cloud itself has a nonuniform density of points, of which some are part of the structure under the transport means.

A further advantageously developing variant of the invention solves these problems during the identification of a level loading surface in the scanned point cloud by the following steps being carried out:
a) discretizing the loading surface, in which only the highest point per voxel is retained. This has the result that the points vertically under the loading surface that are not relevant in this connection are removed,
b) identifying the loading surface as a plane by means of segmentation on the basis of the RANSAC method (RANSAC: random sample consensus), which is a method with which a person skilled in the art is familiar in principle in the literature).

Subsequently, the elements which are arranged on the loading surface are detected. This sub-method for detecting the elements comprises the following steps:
1. dividing points of the point cloud above the loading surface of the transport means into groups of adjacent points by means of a Euclidean clustering,
2. carrying out a further Euclidean clustering for these groups in order to see whether the respective group can be divided further; this second clustering is preferably based on a discrete depiction of the points and is supported primarily on the Z distance (instead of the three-dimensional distance of the previous clustering) ; particularly preferably and if possible, the original cluster is replaced by its own small partitions,
3. creating the geometrical model by analyzing the detected clusters using a square grid in the horizontal plane (the coordinate of the vertical direction is ignored, comparably to the projection in the horizontal plane); if one or more corners of a grid square with points of a cluster is or are empty, the corresponding cluster is divided and depicted as 2 different cuboids in an L configuration; otherwise, the entire cluster is depicted as a cuboid. The list of cuboids is the output of this method step, the geometrical model of the elements on the loading surface.

An advantageously developing variant of the invention for detecting and differentiating elements on the loading surface is provided by an element detection method for analyzing elements or three-dimensional objects in the point cloud, which is generated by the scanner (laser scanner), on the already identified loading surface, wherein the elements are located on or vertically above the loading surface of a transport means (also see “identification of points vertically above the loading surface”). By this means, those elements which can be used for finding the precise loading surface of the trailer are preferably detected. Elements which lie above the internal loading surface of the trailer can thereby preferably be assigned to one of the following classes:
guide elements: these vertical wings (structures) are part of the trailer frame and serve to bring the loading container over the last centimeters of its downward movement into the correct position.
Flippers: these are small guide plates which can be “folded” into the frame when the loading container is pulled over them.
Obstacles: these are all of the elements which are not intended to come into contact with the loading container, e.g. the cab of the truck, parts of the port facility, unexpected objects.

The element detection method here is preferably divided into 3 steps.
I. In a first step, all of the elements located on the loading surface vertically above the loading surface of a transport means obtain a preliminary classification which is based on height: an element is classified as a guide element if it has a height of between 15-50 cm; elements which have a height smaller than 15 cm are classified as what are referred to as flippers; elements which are larger than 50 cm are classified as an obstacle.
II. In a second step, the front and rear ends of the trailer are checked (surrounding region: the 3 m or 2 m or 1.5 m of the longitudinal extent arranged in each case on one side of the longitudinal direction) and the elements arranged there are optionally reclassified.
If an obstacle is found in the front or rear end region, other elements in the vicinity (in the above-defined surrounding region and/or also in the region transversely with respect to the obstacle) of said obstacle are reclassified into obstacles. This step deals with the numerous elements which arise due to a complex obstacle, e.g. a driver's cab.
III. The third step comprises an analysis and optionally a reclassification of the remaining guiding elements and flippers according to the following rules on the basis of the respective relative position:
   In the central region of the loading surface of a transport means, elements categorized as guiding elements are categorized as flippers. While both guiding elements and flippers are present at the boundary, no guiding elements are located in the central region. Finally, all of the preliminary classifications and the reclassified elements are categorized as definitively classified.

An advantageous refinement and development of the method according to the invention consists in the differentiation between unloaded loading surfaces and loaded transport means.
1. Loading surfaces already preliminarily detected by means of method steps already described previously are sorted on the basis of the distance from the ground into, firstly, those loading surfaces, the height level of which lies within a plausible region for a loadable loading surface, and those loading surfaces which lie outside a plausible region for a loadable loading surface. Those loading surfaces which lie within said region are subjected to further method steps, and the others are discarded as such.
2. A “discretization+growing region clustering” is used in order to detect whether a surface can be divided into smaller parts (the “growing region clustering” method is known in principle to a person skilled in the art and is based here on the assumption that the adjacent points within a region have similar height values. The method consists in comparing a point with its neighbors with regard to the third coordinate (COZ), or height. If a similarity criterion is satisfied (difference<threshold value), the point can be assigned to the cluster. Finally, a plurality smaller parts can be produced from a region or a surface which is subjected to said clustering, depending on the threshold value).
3. All of the surfaces which are smaller than the contact area of a smallest possible loading container, in particular an ISO loading container, are rejected.
4. Plane segmentation (preferably: RANSAC (random sample consensus) ) is used to precisely determine the position of the surface.
5. Roof edges of a loading container in the longitudinal direction can preferably be identified by means of a suitable sub-method, which can comprise, for example, the following steps:
   a) one side of the loading container is identified by plane segmentation (preferably: RANSAC (random sample consensus)),
   b) a roof edge is identified as a mathematical intersecting line of said plane with the surface of the loading container.
   c) if steps a) or b) do not lead to success (for example because the quality of the point cloud is insufficient), a further step is carried out: c′ ) the extreme points of the surface of the loading container in the direction of the roof edge (longitudinal direction of the transport means or transversely with respect to the longitudinal direction) are identified; the edge is then identified as a secant of the extreme points.
   d) the orientation of the container is calculated with reference to the roof edges.
   e) it is detected with a further sub-method whether a twin loading container is involved (see below: sub-method for twin loading containers), and, if this is the case, the loading container is divided into two smaller loading containers corresponding to the detected gap between the loading containers.
   f) the surface is stretched or compressed to the ISO standard length. This takes place on the basis of the local resolution of the point cloud, i.e. an edge with sparse points and missing information is more deformable than an edge which is well defined by an abundance of points.

Twin loading containers are two loading containers (generally in each case 20 foot loading containers) which are arranged one behind the other with a relatively small distance in between (smaller than 50 cm, in particular smaller than 30 cm). As a rule, these loading containers are identical in length, and therefore this distance or this gap is located in the center of said twin combination.

A sub-method for detecting twin loading containers or else double loading containers can preferably comprises the following steps:
1. identifying the region in which the gap is anticipated,
2. discretizing the loading container as a two-dimensional profile (as seen from the side, discretized into 2D bins),
3. checking whether an empty field is arranged in the center, and, if that is the case, classifying the loading container as a twin loading container,
4. checking whether the analyzed loading container is depicted with a significant number of points below or above the average surface and, if that is the case, classifying the loading container as a twin t loading container,
5. repeating steps 2-4 with a different discretization basis in each case—i.e. a different starting point at which the discretization starts, and therefore the discretization steps are each somewhat displaced so that artefacts of the scan do not have any effect on the result quality.

The invention is described in more detail below with reference to a specific exemplary embodiment for clarification purposes. In the figures:

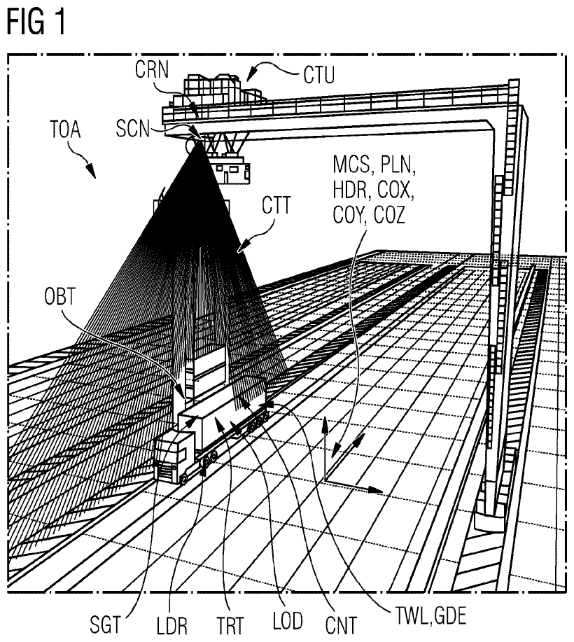

FIG. 1 shows a schematic, three-dimensional illustration of a handling location,

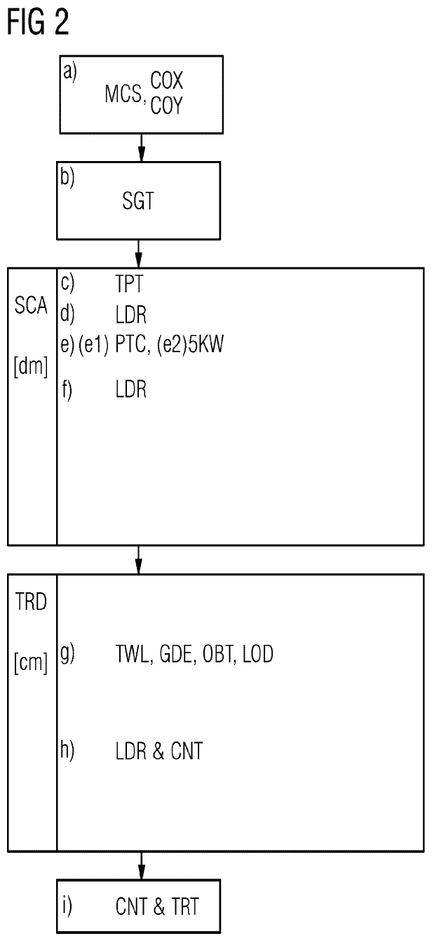

FIG. 2 shows a schematic sequence diagram of the method according to the invention,

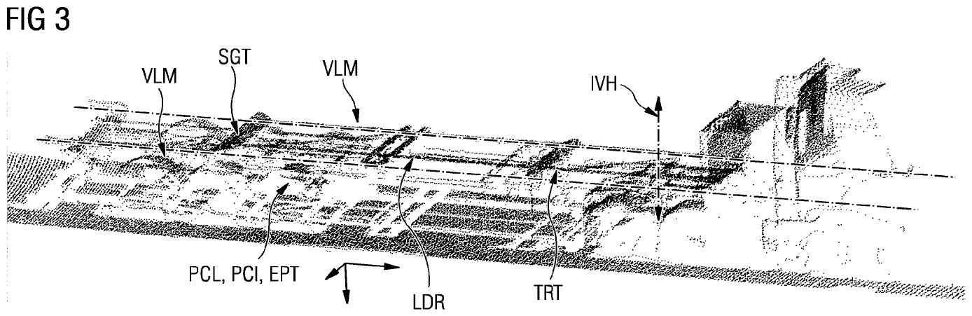

FIG. 3 shows a point cloud of a transport means,

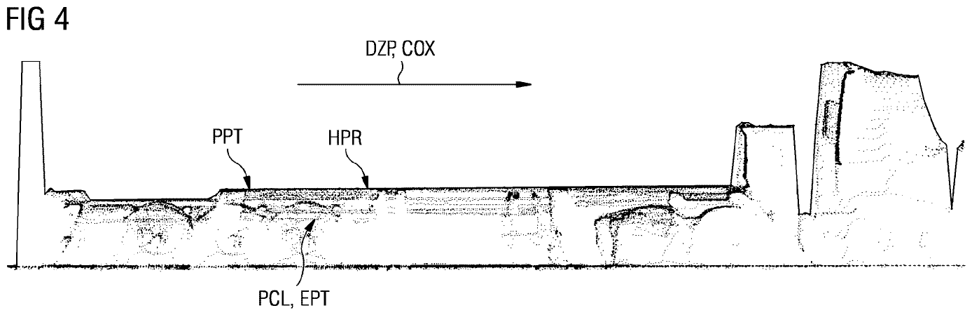

FIG. 4 shows a profile of the transport means from FIG. 3,

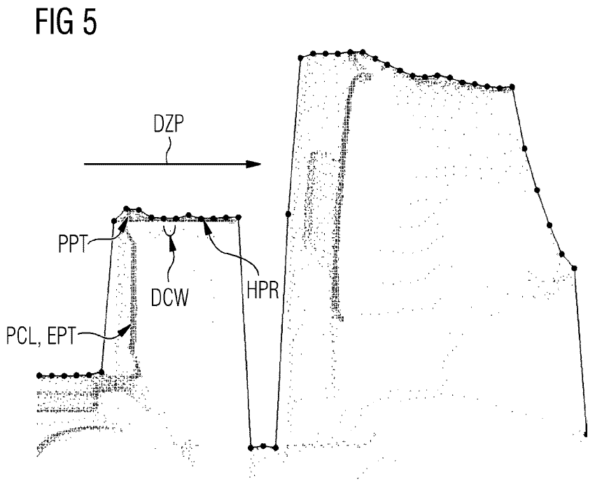

FIG. 5 shows an illustration of a discretization with reference to the detail of a driver's cab of the transport means from FIGS. 3 and 4,

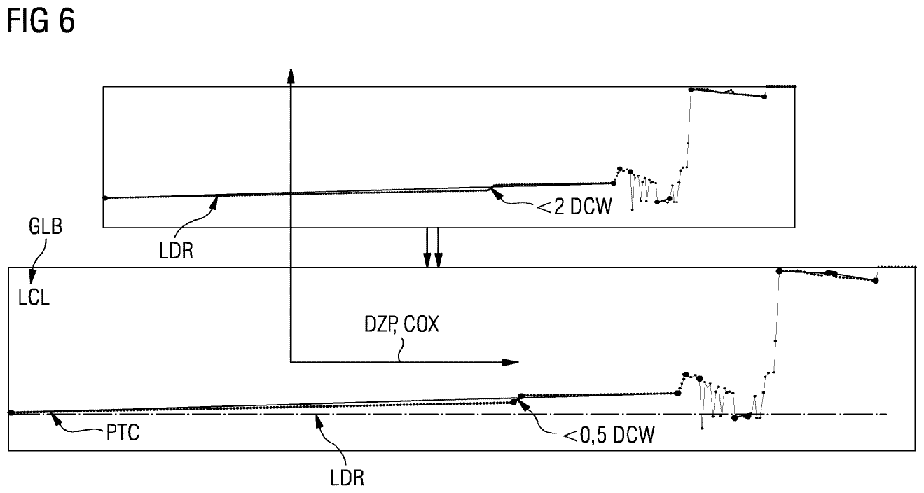

FIG. 6 shows an analysis of the profile from FIGS. 4 and 5,

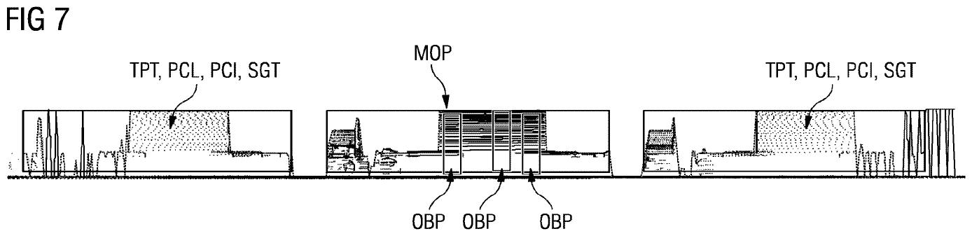

FIG. 7 shows a determination of transport means limits,

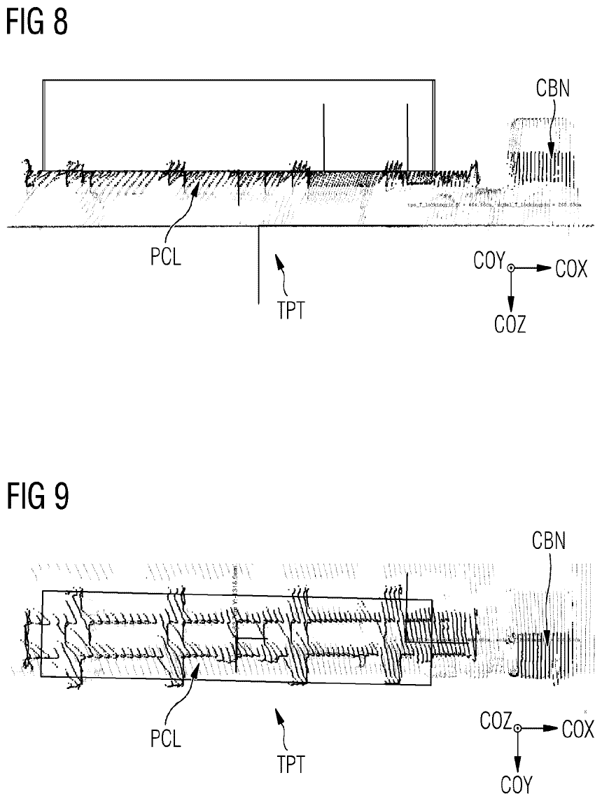

FIG. 8 shows a side view of an asymmetric cab,

FIG. 9 shows a top view of an asymmetric cab,

FIG. 10 shows an initial position of the point cloud,

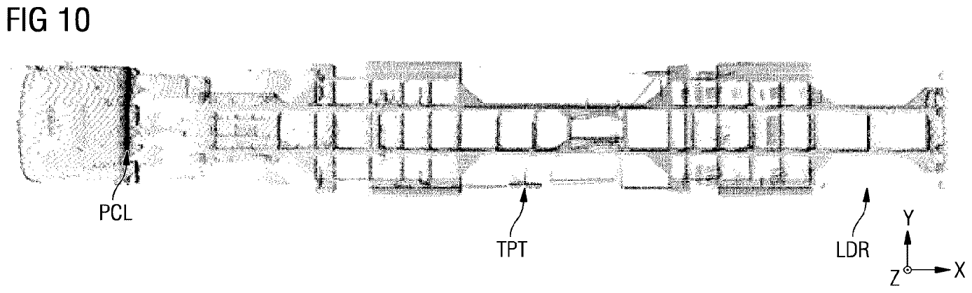

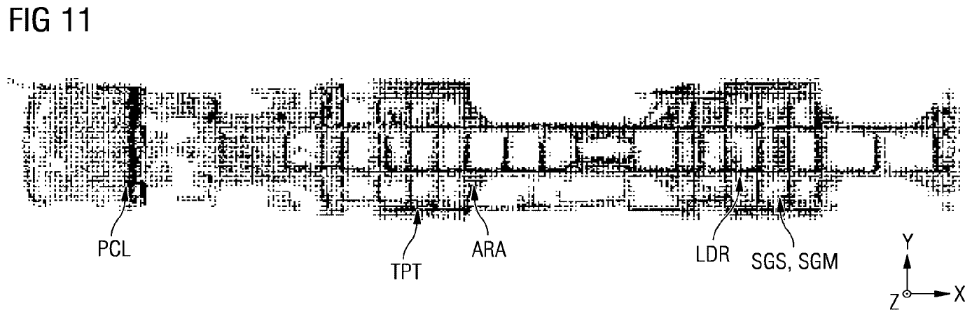

FIG. 11 shows a screened vehicle,

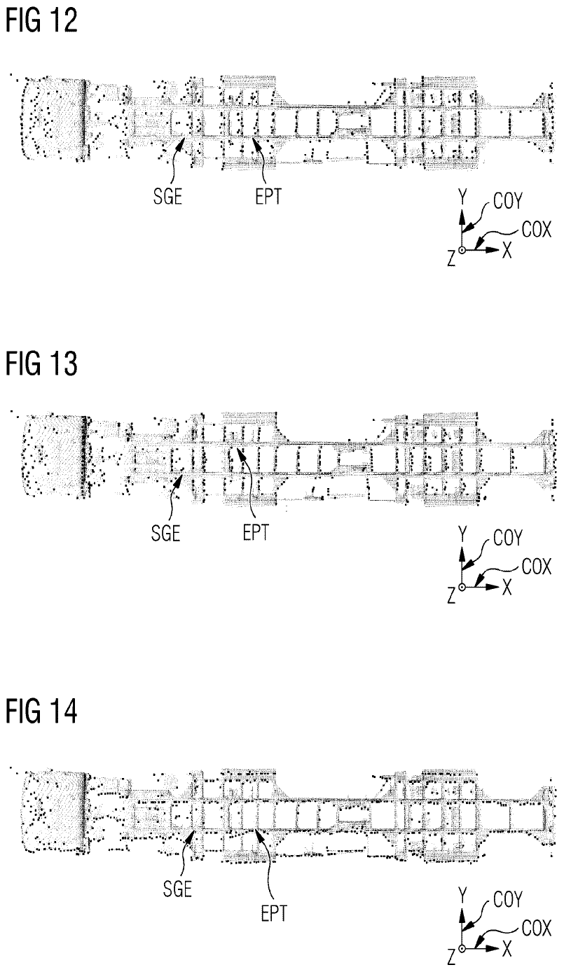

FIG. 12 shows falling edge points in the X direction,

FIG. 13 shows rising edge points in the X direction,

FIG. 14 shows falling edge points in the Y direction,

FIG. 15 shows rising edge points in the Y direction,

FIG. 16 shows lines on the basis of falling edge points in the X direction,

FIG. 17 shows lines on the basis of rising edge points in the X direction,

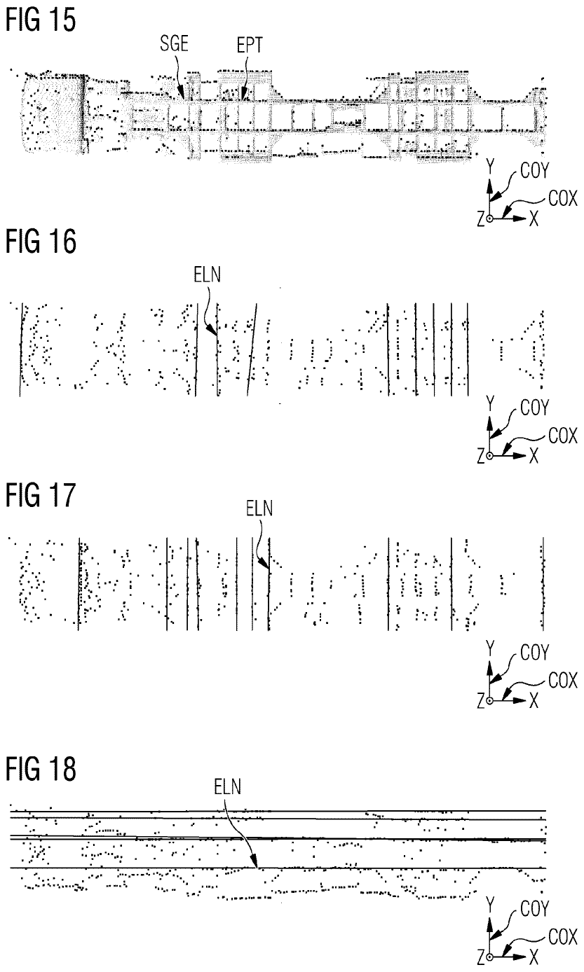

FIG. 18 shows lines on the basis of falling edge points in the Y direction,

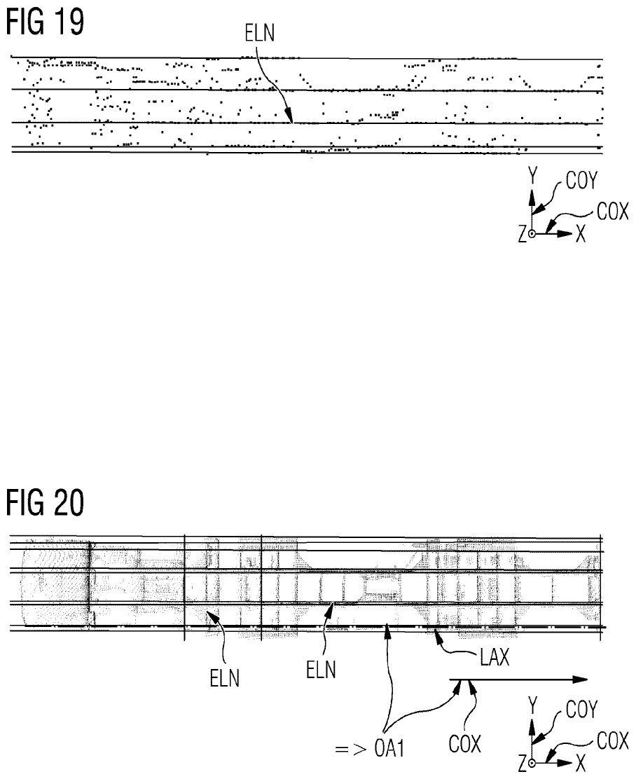

FIG. 19 shows lines on the basis of rising edge points in the Y direction,

FIG. 20 shows lines on the basis of edge points in the X direction and Y direction,

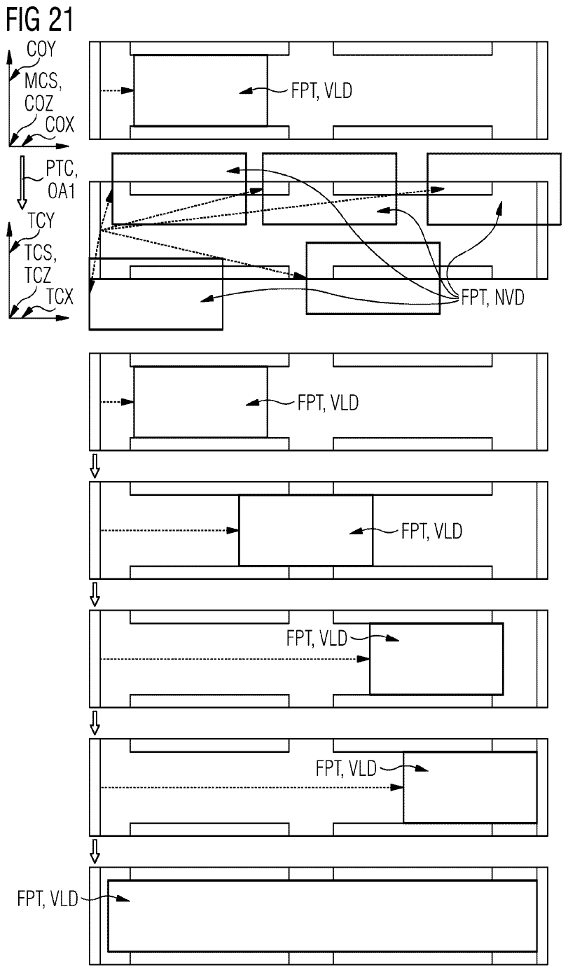

FIG. 21 shows a method for classifying a loading surface,

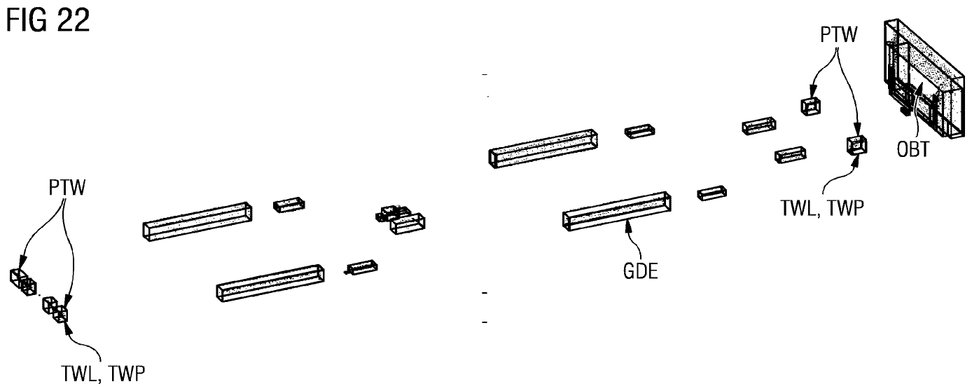

FIG. 22 shows a method for detecting elements on a loading surface,

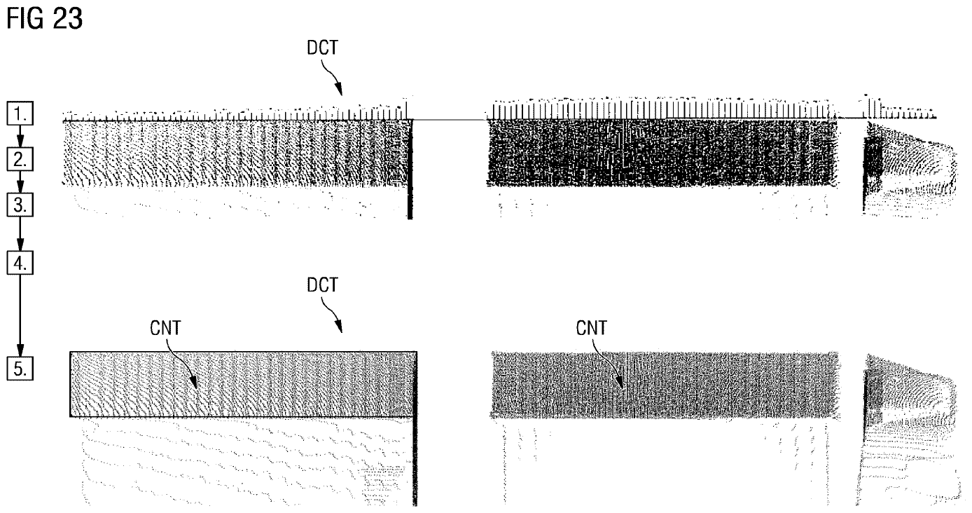

FIG. 23 shows a method for detecting double loading containers,

FIG. 24 shows a point cloud of an internal transport means with marked elements,

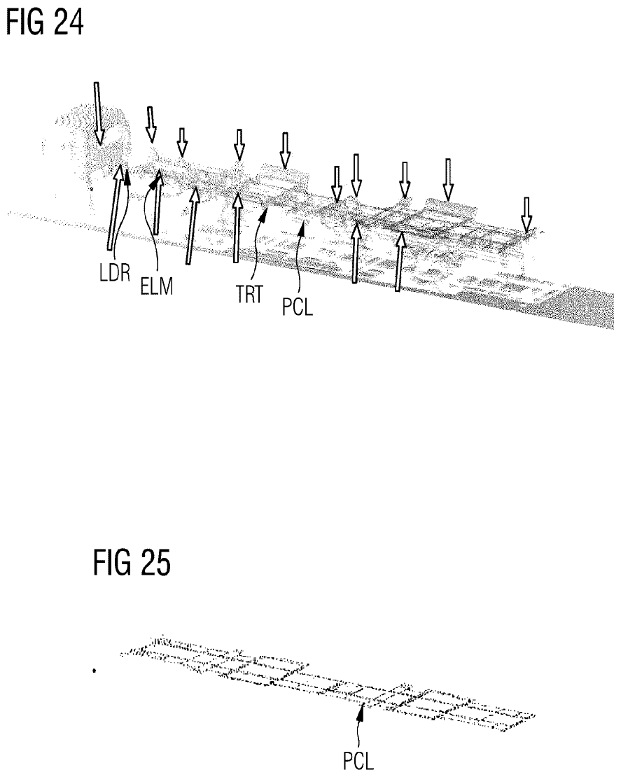

FIG. 25 shows a detected plane of the loading surface,

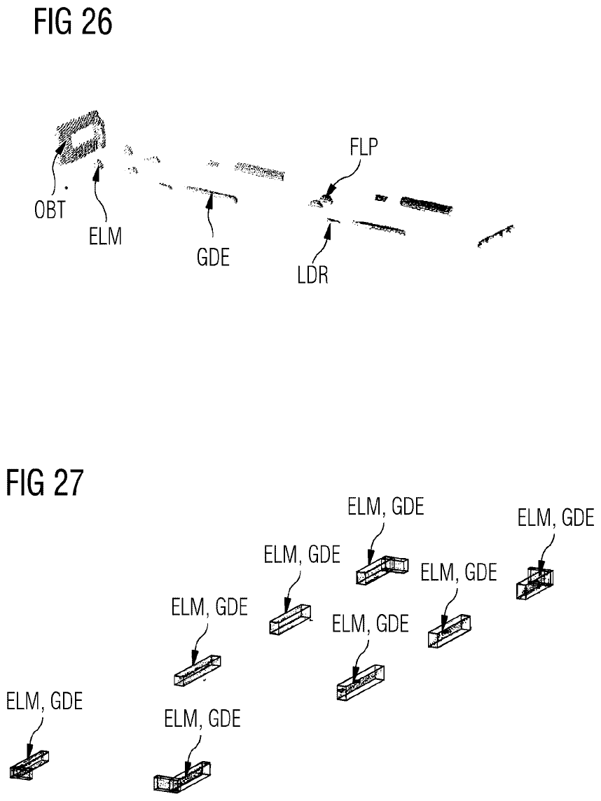

FIG. 26 shows points of elements above the loading surface,

FIG. 27 shows detected elements on the loading surface,

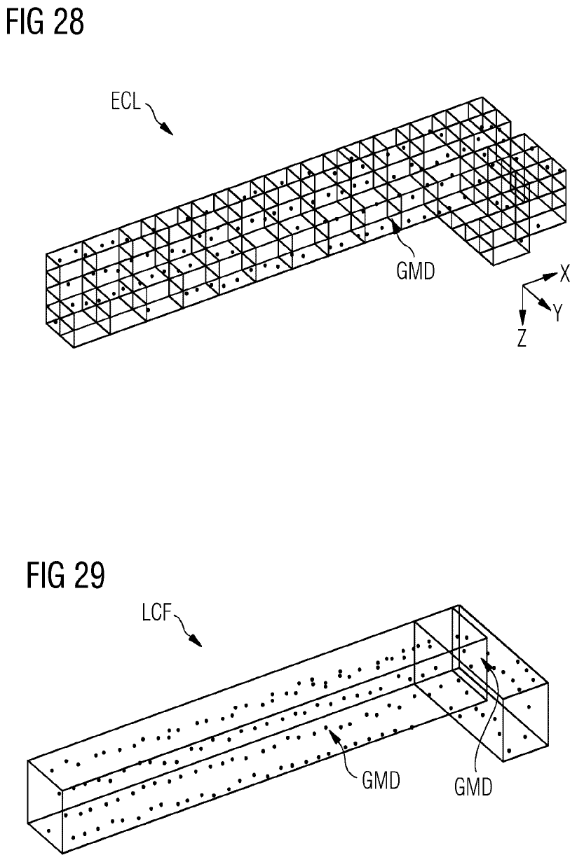

FIG. 28 shows a discretization of elements on the loading surface,

FIG. 29 shows a detected cuboid of elements,

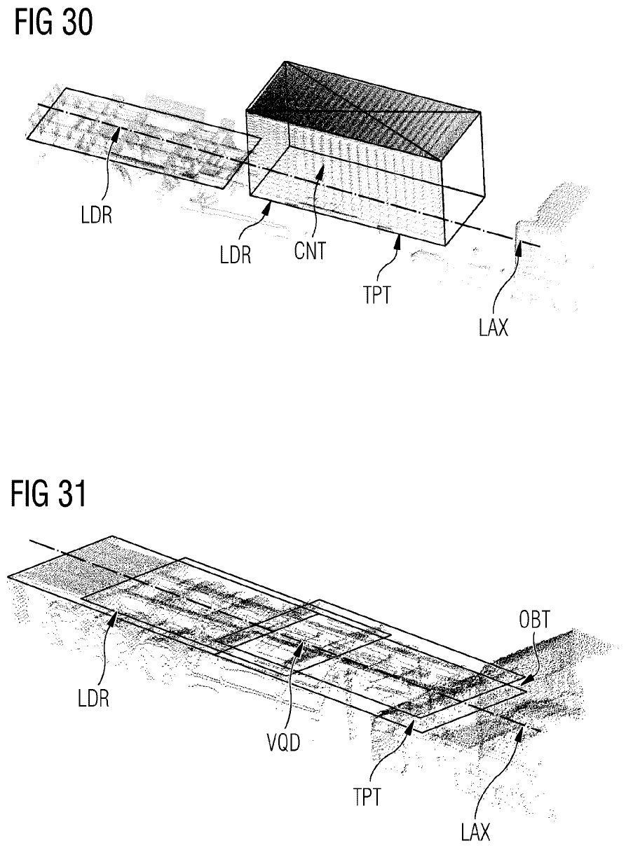

FIG. 30 shows a point cloud of a half-loaded transport means,

FIG. 31 shows a depositing position detected on the loading surface by means of fastening elements,

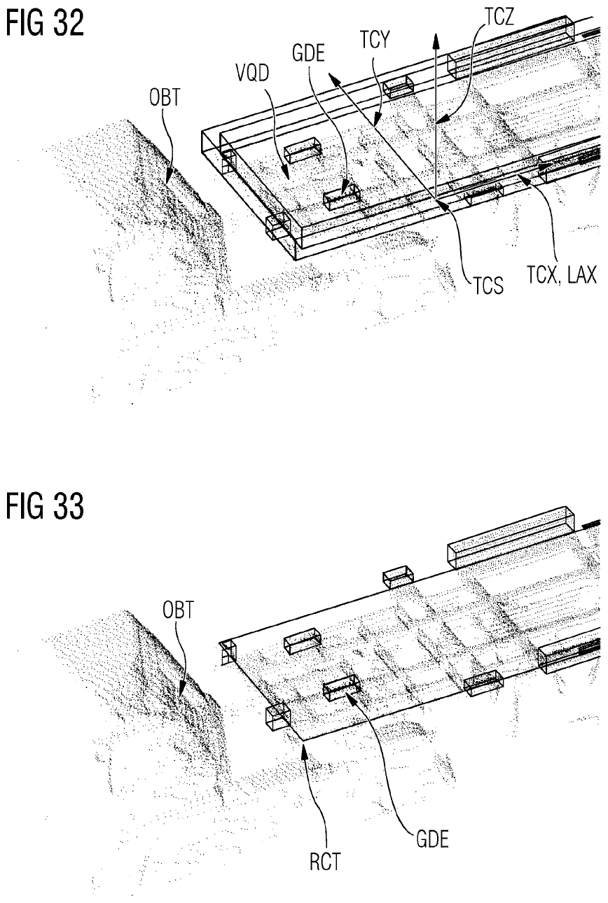

FIG. 32 shows a maximum and a minimum circumferential geometry of the fastening elements,

FIG. 33 shows a depositing position detected by means of guide elements,

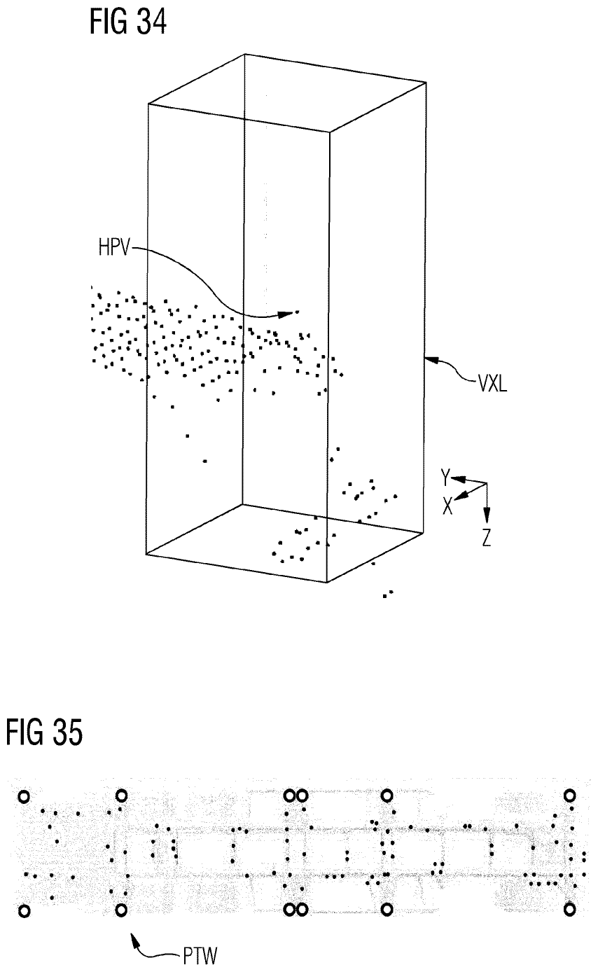

FIG. 34 shows a reduction in a voxel to a vertical maximum value per voxel,

FIG. 35 shows local maxima of the loading surface and detected fastening elements,

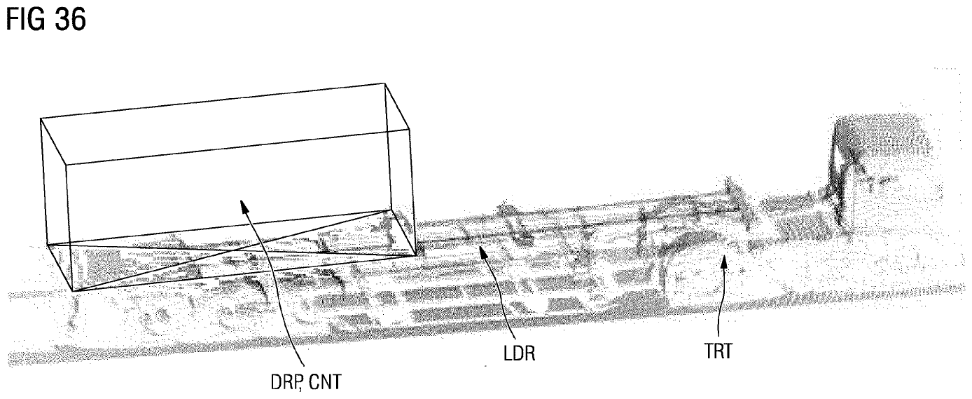

FIG. 36 shows transport means with a detected depositing position with reference to fastening elements.

FIG. 1 shows a handling place or handling region TOA of container terminal and a handling device CTT with a crane CRN. The handling device serves for the loading of containers or loading containers CNT by means of a crane CRN onto loading surfaces LDR or from loading surfaces LDR. The current technical trend is moving toward fully automated cranes CRN with at least one control unit CTU, the cranes operating very substantially autonomously. FIG. 1 here shows that the handling device CTT records the surface geometry of the transport means TRT, including the loading surface LDR and/or the loading container CNT, by means of a scanner SCN or a scanning process. Use is preferably made here of a laser scanner which has the desired accuracy and reliability and generates what is referred to as a point cloud PCL, the points EPT each defining coordinates of the surface of the scanned region.

FIG. 2 shows a schematic sequence diagram of the method according to the invention. The loading of a transport means TPC with a loading container CNT takes place in principle in the following steps:
a) defining a spatially fixed coordinate system MCS (FIG. 1), the first and second coordinate directions COX, COY of which are located substantially in a horizontal plane PLN and the third coordinate direction COZ of which extends substantially vertically in a height direction HDR,
B) Recording a surface geometry SGT in the region of the handling region TOA,
c) identifying a region of a transport means TPT,
d) determining the location of a loading surface LDR of the transport means TPT,
e) determining a spatial angular position of a loading surface of the transport means TPT,
f) identifying and classifying one or more determined loading surfaces LDR of the transport means TPT,
g) detecting fastening elements TWL and/or guide elements GDE and/or obstacles OBT and/or loads LOD on the loading surface LDR,
h) selecting a loading container CNT which is suitable for a determined loading surface LDR and the associated fastening elements TWL of the transport means TRT,
i) loading the loading surface LDR of the transport means TRT with the selected loading container CNT.

FIG. 3 shows the recording of a surface geometry SGT of a transport means TRT, the loading surface LDR of which is not loaded with a loading container CNT. The recording taken by means of a laser scanner consists of a multiplicity of points EPT which, in the spatially fixed coordinate system MCS, are each defined as values of three coordinate directions COX, COY, COZ, the multiplicity of points EPT also being referred to as a point cloud PCL.

FIG. 4 shows, as a development of the invention, a readout of a method which generates a height profile HPR along a profile direction DZP consisting of profile points PPT.

FIG. 5 shows the height profile HPR consisting of the profile points PPT with reference to the detail of a driver's cab of the transport means TPT from FIGS. 3 and 4.

Before the actual profile is formed, an expedient development of the invention makes provision for a reduction in the point cloud PCL of the surface geometry such that lateral regions of the recorded point cloud PCL are firstly removed from an initial point cloud PCI. In detail, a step-by-step procedure is provided, comprising:
entering the point cloud PCL of the surface geometry SGT as an initial point cloud PCI,
defining volumes VLM of the initial point cloud PCI, the volumes in each case extending next to one another in the manner of disks along the first horizontal coordinate direction COX with a certain discretization width DCW with respect to the first horizontal coordinate direction COX,
reducing the initial point cloud PCI by the points of a number of outer volumes VLM (the severing of the outer volumes VLM is indicated in FIG. 3 by means of the chain-dotted lines; these lines run parallel to the first coordinate direction COX), such that 30%-80%, preferably 45%-55%, particularly preferably 50%, of the overall width of the volumes VLM remain,
defining the remaining volumes VLM as a new point cloud PCI.

Furthermore, depending on the resolution of the point cloud PCL, it may be expedient to remove points from the point cloud that do not lie in a height range that definitely does not lie in the region of a potential loading surface LDR. For this purpose, an expedient range of valid height values for the third coordinate direction COZ lies, for example, between 20 cm-700 cm. In detail, a step-by-step procedure is provided, comprising:
defining a range of valid height values IVH for the third coordinate direction COZ of the initial point cloud PCI,
discarding the points EPT in the volumes VLM which exclusively have points EPT with height values outside the range of valid height values IVH (see schematically FIG. 3),
defining these remaining points EPT as a new point cloud PCI which includes the transport means TPT.

The creation of the actual height profile HPR takes place according to the basic routine shown here below and in detail comprises the steps of:
entering the point cloud PCL of the surface geometry SGT as an initial point cloud PCI,
selecting a horizontal coordinate direction COX, COY as a profile direction DZP,
defining volumes VLM of the initial point cloud PCI, the volumes in each case extending next to one another in the manner of disks along the other horizontal coordinate directions COY, COX, not selected, with a certain discretization width DCW (also see FIG. 5) with respect to the profile direction DZP,
generating a height profile HPR in the profile direction DZP from profile points, with a profile point PPT being defined for each volume,
wherein the coordinate of the profile point PPT in the profile direction DZP is allocated as a coordinate value of the profile direction in each case to a determined position of the discretization width DCW of the volume VLM,
wherein said determined position for each volume VLM is at the same point of the discretization width DCW,
wherein the coordinate of the profile point PPT in the height direction HDR is allocated as a coordinate value of the highest value in each case present in the volume VLM of the third coordinate direction COZ of a point EPT.

This basic routine permits a flexible selection of the profile direction DZP, and therefore profiles can be created both in the first horizontal coordinate direction COX and also along the second horizontal coordinate direction COY.

FIG. 5 shows details of a driver's cab of a transport means TPT, wherein the individual profile points PPT are each spaced apart by a discretization width DCW. It is particularly expedient in this case if the discretization width DCW is between 1 cm-1 m, preferably 5 cm-15 cm, particularly preferably 10 cm, and therefore details of the loading surface can be detected from the resulting height profile HPR.

FIG. 6 illustrates the result of two sub-methods GLB, LCL of a method, which advantageously develops the invention, for identifying a loading surface LDR of the transport means TPT. First of all, a relatively rough analysis of the height profile of the transport means TPT is undertaken, which may also be referred to as a global approach, relatively rough approach or as the first sub-method GLP:
carrying out the above-defined basic routine for the point cloud PCL, with the following stipulations:
   a. the first horizontal coordinate direction COX is the profile direction DZP, thus resulting in a height profile HPR extending along the first horizontal coordinate direction COX,
   b. wherein the determined discretization width DCW is between 1 cm-1 m, preferably 5 cm-15 cm, particularly preferably 10 cm,
dividing the height profile HPR into segments by determining a segment by means of the stipulation that, in a step-by-step evaluation from point to point, the vertical distance from the previous point is Smaller than 2 horizontal discretization widths DCW,
defining the longest segment determined in such a way as a preliminary estimation of the loading surface extent PLE along the first horizontal coordinate direction COX.

It is expedient here to define a vertical offset VFS from the value range of the third vertical coordinate direction COZ of the estimation of the loading surface extent PLE.

The second sub-method LCL (FIG. 6) for identifying a loading surface of the transport means TPT is undertaken as a finer analysis of the height profile (local approach) of the transport means such that a determination of the vertical angular position or inclination or else tilting of the loading surface of the transport means TPT is also made possible. In detail:
carrying out the above-defined basic routine for the point cloud PCL, in particular for the point cloud PCI exclusively in the region of the preliminary estimation of the loading surface extent PLE according to the previous global approach, with the following stipulations:
   a. the first horizontal coordinate direction COX is the profile direction DZP, thus resulting in a height profile HPR extending along the first horizontal coordinate direction COX,
   b. wherein the determined discretization width DCW is between 1 cm-1 m, preferably 5 cm-15 cm, particularly preferably 10 cm,
dividing the height profile HPR into segments by determining a segment by means of the stipulation that, in a step-by-step evaluation from point to point, the vertical distance from the previous point is smaller than half a horizontal discretization width DCW,
defining the longest segment determined in such a manner,
determining an angle of inclination PTC of the longest segment determined in such a manner as the angle of inclination PTC of the loading surface LDR.

If a plurality of transport means TPT are lined up one behind another, the method defined step-by-step below makes it possible to delimit the individual transport means TPT from one another, as is depicted as the result in FIG. 7. The determination of the ends of a transport means TPT in the first horizontal coordinate direction COX comprises, in detail:
entering the point cloud PCL of the surface geometry SGT as an initial point cloud PCI,
defining volumes VLM of the initial point cloud PCI, the volumes in each case extending next to one another in the manner of disks along the second horizontal coordinate direction COY with a second discretization width DCW of at least 15 ft, preferably at least 20 ft,
carrying out the steps according to the above-defined basic routine for each individual point cloud PCL arranged in each of the volumes VLM, with the following stipulations:
   a. the second horizontal coordinate direction COY is the profile direction DZP, thus resulting in a height profile HPR extending along the second horizontal coordinate direction COY,
   b. wherein the determined discretization width DCW is between 1 cm-1 m, preferably 5 cm-15 cm, particularly preferably 10 cm. Sections which are too narrow are rejected by comparing the widest length of the height profile HPR with respect to the second horizontal coordinate direction COY with a minimum value and discarding the points EPT located in the respective volume VLM if the widest length lies below the minimum value. Finally, the non-discarded portion of the initial point cloud PCI is defined as a new point cloud PCL which comprises the transport means TPT.
   Furthermore, it is provided that the above-defined basic routine is carried out for the newly defined point cloud PCL, with the following stipulations:
   the first horizontal coordinate direction COX is the profile direction DZP, thus resulting in a height profile HPR extending along the first horizontal coordinate direction COX,
   wherein the determined discretization width DCW is between 1 cm-1 m, preferably 5 cm-15 cm, particularly preferably 10 cm,
dividing the profile into two-dimensional object profiles OBP, wherein an object profile OBP extends over a region of the first horizontal coordinate direction COX which exclusively has profile points with height values of the height profile HPR of greater than 0,
combining object profiles OBP which are at a distance of less than 3 m, in particular less than 1.5 m, from one another in the first horizontal coordinate direction COX to form in each case a common object profile MOP, and therefore the transport means are in each case located in the resulting regions of the first horizontal coordinate direction COX of the common object profiles MOP.

FIG. 8 shows a side view of a transport means with a cab CBN. FIG. 9 shows a top view (bird's-eye view) thereof. The point cloud PCL is in practice not always symmetrical with respect to the, e.g., first coordinate direction COX or the direction of travel, as a result of which an, e.g., horizontal angular position of the transport means TPT or of the loading surface LDR is frequently calculated erroneously according to conventional approaches. In the case of an asymmetrical cab CBN—the transport means TPT configured in the form of terminal tractors are frequently designed in this way, as in both FIGS. 8 and 9—many methods which make use, for example, of only one profile view or a vertical section are unsuccessful.

An advantageous development of the invention makes provision firstly to identify edges of the loading surface LDR of the transport means TPT from the point cloud PCL. FIG. 10 firstly shows the initial position of the point cloud PCL. FIG. 11 shows the provision of a grid SGS consisting of individual grid elements SGM of the region ARA. Subsequently, those grid elements SGM which contain points EPT are selected and grid elements SGM which comprise an edge of the transport means TPT are determined as edge grid elements SGE. In the next step, the edge grid elements SGE are sorted depending on the respective edge orientation on the basis of the spatial coordinate system MCS into groups of edge grid elements SGE containing edge points EPT, the groups comprising:
FIG. 12: falling edge points EPT in the first horizontal coordinate direction COX,
FIG. 13: rising edge points EPT in the first horizontal coordinate direction COX,
FIG. 14: falling edge points EPT in the second horizontal coordinate direction COY,
FIG. 15: rising edge points EPT in the second horizontal coordinate direction COY.

FIGS. 16 to 19 show detected edge lines ELN with reference to the edge points EPT by multiple line segmentations for the respective groups, wherein, in the line segmentation, a line is placed in each case through as many predefined surrounding volumes of edge points EPT as possible and said edge points EPT are replaced by the respective line. In detail, the following lines are depicted in the figures: FIG. 16 shows lines on the basis of falling edge points in the X direction, FIG. 17 shows lines on the basis of rising edge points in the X direction, FIG. 18 shows lines on the basis of falling edge points in the Y direction, FIG. 19 shows lines on the basis of rising edge points in the Y direction. FIG. 20 finally shows the overall view of the detected lines on the basis of edge points in the X direction and Y direction.

Expediently, the detected edges of the loading surface LDR can be used for determining an inclination of the loading surface LDR using the following sub-method comprising the steps of:
combining edge lines ELN to form combined edge lines ELN, wherein those edge lines ELN are combined which enclose the same angle, apart from an angular deviation region, in relation to the first horizontal coordinate direction COX,
determining a quality factor for the edge lines ELN and/or combined edge lines ELN, wherein the quality factor is rising or proportionally rising with the number of edge points EPN which have been replaced by the edge lines ELN or the edge lines ELN on which the combined edge line ELN is based,
establishing a longitudinal axis LAX of the transport means TPT, wherein the direction of those edge lines ELN and/or combined edge lines ELN which have an angular deviation from the first horizontal coordinate direction COX which is smaller than 10° and the quality factor of which is highest compared to the others are established as the direction of the longitudinal axis LAX,
determining a first offset angle OA1 between the first horizontal coordinate direction COX and the longitudinal axis LAX of the transport means TPT.

FIG. 21 illustrates an advantageously developing method of the invention for classifying a loading surface LDR, wherein the procedure is, for example, as follows:
on the basis of the spatially fixed coordinate system MCS and using the angle of inclination PTC and the first offset angle OA1, defining a transport means coordinate system TCS with a first substantially horizontal transport means coordinate direction TCX along the longitudinal axis LAX of the transport means TPT, with a second substantially horizontal transport means coordinate direction TCY transversely with respect to the first horizontal transport means coordinate direction TCX, and with a third substantially vertical third transport means coordinate direction TCZ which is perpendicular to the other transport means coordinate directions TCX, TCY,
defining a two-dimensional reference contour ISO corresponding to a contact area FPT of a loading container with respect to the transport means coordinate system TCS,
identifying a level loading surface LDR of a transport means to be loaded as claimed in at least one of the preceding claims 1 to 14, in particular as claimed in claims 9-14,
defining a two-dimensional loading surface contour as a projection in the direction H the third transport means coordinate direction TCZ of the level loading surface LDR,
repeating (FIG. 21 shows consecutively here by way of example valid (VLD) and invalid (NVD) tests for positioning the ISO loading container and then the valid tests are combined) of a virtual test to superimpose the reference contour on a reference contour position with the loading surface contour in such a manner that certain criteria are met,
   the certain criteria (other reference contour positions are invalid (NVD) ) being (it is also possible to use only a selection of these criteria):
      no edge of the reference contour is located outside the loading surface contour, and
      the reference contour is arranged completely in the loading surface contour, and
      there is no edge of the loading surface in the region of the overlapping of the reference contour with the loading surface contour,
   wherein the reference contour positions which meet the certain criteria are classified as valid reference contour positions VLD,
   wherein, during each repetition, the reference contour is moved to a different reference contour position with a predefined step width with respect to the loading surface contour in the first transport means coordinate direction TCX, wherein the test is repeated until the reference contour has passed through the test contour along all possible steps in the first transport means coordinate direction TCX,
   wherein, during each repetition, the reference contour is moved with a predefined step width with respect to the test contour in the second transport means coordinate direction TCY, wherein the test is repeated until the reference contour has passed through the test contour along all possible steps along the second transport means coordinate direction TCY and until the reference contour has passed through the test contour along all possible steps along the first transport means coordinate direction TCX,
wherein mutually overlapping reference contours at valid reference contour positions are joined together to form a common valid loading surface LDR.

An advantageous development of the invention makes provision that the loading surface LDR of a transport means TPT is classified as a loaded loading surface LDR if the points of the loading surface LDR lie in the region of an anticipated height of a loading container roof in the vertical coordinate direction COZ (also see: FIG. 30, point cloud of a half-loaded transport means).

FIG. 22 shows the result of a method for detecting elements (fastening elements TWL and/or guide elements GDE and/or obstacles OBT and/or loads LOD) on a loading surface LDR. First of all, according to one of the above-described methods, a loading surface LDR has been identified. Subsequently, fastening elements TWL are detected by:
selecting those points of the point cloud PCL in the horizontal region of the identified loading surface LDR which, with respect to a predefined surrounding volume, have a local maximum value of the third coordinate direction COZ as potential fastening element positions TWP (also see FIGS. 34, 35),
defining predefined patterns PTW (also see FIG. 35) of horizontal arrangements of fastening elements TWL,
comparing the patterns PTW with the potential fastening element positions TWP to determine a best correspondence, wherein those potential fastening element positions TWP without a correspondence to an element of a pattern PTW are discarded and those with a correspondence are established as fastening element positions TWP.

Branch know-how is used in respect of the predefined patterns PTW. Loading containers CNT or containers are generally fastened on a trailer by four fastening elements TWL or twistlocks. This involves a twistlock located at each lower corner of the container. Use is also made of the fact that the width of loading containers CNT is standardized (https://de.wikipedia.org/wiki/ ISO-Container).

FIG. 23 illustrates a method, which can advantageously develop the invention, for detecting double loading containers or twin loading containers DCT. Twin loading containers DCT are two loading containers CNT (generally 20 foot loading containers in each case) which are arranged one behind another with a relatively small distance in between (e.g. 50 cm or 30 cm—i.e. small in relation to the conventional distance between transport means). Said loading containers CNT are generally identical in length, and therefore said distance or said gap is located in the center.

A sub-method for detecting twin loading containers or else double loading containers can preferably comprise the following steps:
1. identifying the region in which the gap is anticipated (in this case, the center of the double arrangement is preferably analyzed, with it particularly preferably being assumed that the individual loading containers each have a length of 20 ft),
2. discretizing the loading container as a two-dimensional profile (as seen from the side, discretized into 2D bins),
3. checking whether an empty arranged in the center, and, if that is the case, classifying the loading container as a twin loading container,
4. checking whether the analyzed loading container is depicted with a significant number of points below or above the average surface and, if that is the case, classifying the loading container as a twin loading container,
5. repeating steps 2-4 with a different discretization basis in each case—i.e. a different starting point at which the discretization starts, and therefore the discretization steps are each somewhat displaced so that artefacts of the scan do not have any effect on the result quality.

FIG. 24 shows a point cloud PCL of an internal transport means TRT with marked elements ELM on a loading surface LDR. An advantageous refinement of this procedure provides the following steps for detecting and differentiating certain fastening elements TWL:
identifying points vertically above the loading surface LDR with respect to the third transport means coordinate direction TCS (see, for example, FIG. 25: detecting the plane of the loading surface LDR),
determining local maxima of the surface geometry in the vertical coordinate direction in the region of the identified loading surface LDR (see, for example, FIG. 26: isolating the points of elements above the loading surface).

A further advantageously developing variant of the invention for detecting and differentiating elements on the loading surface is provided by an element detection method which is applied to a point cloud PCL, which is generated by means of a scan or laser scan, of an unloaded transport means TPT, in particular of a predetermined type, in order to find elements (i.e. three-dimensional objects, fastening elements, obstacles, guide elements) which are relevant for determining the precise loading region or the loading surface LDR, i.e. for determining a precise position of a loading container CNT on the loading surface LDR of the transport means TPT.

For this purpose, the following steps are carried out:
1. identifying a level loading surface LDR in the scanned point cloud PCL (see FIG. 25: detecting the plane of the loading surface LDR),
2. detecting all of the points vertically above the loading surface LDR (see FIG. 26: isolating the points of elements ELM above the loading surface LDR),
3. dividing the detected points vertically above the loading surface LDR into different elements ELM (FIG. 27: detected elements on the loading surface-here guide elements GDE),
4. creating a geometrical model GMD for the different elements for further assessment or classification of the elements ; (FIG. 28: discretization of elements on the loading surface, FIG. 29: detected cuboids of elements).

In practice, during the identification of a level loading surface LDR in the scanned point cloud PCL, the following problems arise:
3. the plane of the loading surface LDR is rotated out of the horizontal position of an unknown roll, pitch and yaw angle,
4. the point cloud itself has a nonuniform density of points, of which some are part of the structure under the transport means.

A further advantageously developing variant of the invention solves these problems during the identification of a level loading surface LDR in the scanned point cloud PCL by the following steps being carried out:
c) discretizing the loading surface LDR, in which only the highest point HPV per voxel VXL is retained (see FIG. 34: reduction of a voxel VXL to a vertical maximum value per voxel VXL). This has the result that the points vertically under the loading surface that are not relevant in this connection are removed. An effect of this step is the acceleration of the method without a loss in accuracy.
d) On the basis of the point cloud PCL reduced in such a way, the loading surface is identified as a plane by means of segmentation on the basis of the RANSAC method (RANSAC: random sample consensus); e.g.: https://en.wikipedia.org/wiki/Random sample consensus).

Subsequently, the elements which are arranged on the loading surface LDR are detected. This sub-method for detecting the elements ELM comprises the following steps:
1. dividing points of the point cloud above the loading surface LDR of the transport means TPT into groups of adjacent points by means of a Euclidean clustering.
2. Carrying out a further Euclidean clustering ECL for these groups in order to see whether the respective group can be divided further (FIG. 28 here shows a discretization of elements on the loading surface). This second clustering is preferably based on a discrete depiction of the points and is supported preferably primarily, particularly preferably exclusively, on the Z distance (instead of the three-dimensional distance of the previous first Euclidean clustering). Particularly preferably and if possible, the original cluster is replaced by its own small partitions.
3. Creating the geometrical model by analyzing the detected clusters using a square grid in the horizontal plane (the coordinate of the vertical direction is ignored, comparably to the projection in the horizontal plane; see FIG. 29: detected cuboids of elements GMD). If one or more corners of a grid square with points of a cluster is or are empty, the corresponding cluster is divided and depicted as 2 different cuboids in an L configuration LCF. Otherwise, the entire cluster depicted as a cuboid. The list of the cuboids GMD is the output of this method step, the geometrical model of the elements on the loading surface. Detected elements on the loading surface are shown by way of example in FIG. 27.

An advantageously developing variant of the invention for detecting and differentiating elements on the loading surface LDR is provided by an element detection method for analyzing elements or three-dimensional objects in the point cloud CLD, which is generated by the scanner (laser scanner) on the already identified loading surface LDR, wherein the elements are located on or vertically above the loading surface LDR of a transport means TPT (also see “identification of points vertically above the loading surface”). By this means, those elements which can be used for finding the precise loading surface LDR of the trailer are preferably detected. Elements which lie above the internal loading surface LDR of the trailer can thereby preferably be assigned to one of the following classes:
guide elements: these vertical wings (structures) are part of the trailer frame and serve to bring the loading container over the last centimeters of its downward movement into the correct position,
flippers: small guide plates which can be “folded” into the frame when the loading container is pulled over them,
obstacles: everything not intended to come into contact with the loading container, e.g. the cab of the truck, parts of the port facility, unexpected objects.

The element detection method partially illustrated by way of results in FIGS. 26 and 27 is preferably divided here into 3 steps.
IV. In a first step, all of the elements located on the loading surface LDR (see, for example, FIGS. 26 and 27) vertically above the loading surface LDR of a transport means obtain a preliminary classification which is based on height: an element is classified as a guide element GDE if it has a height of between 15-50 cm; elements which have a height smaller than 15 cm are classified as what are referred to as flippers FLP; elements which are larger than 50 cm are classified as an obstacle OBT.
V. In a second step, the front and rear ends of the trailer are checked (the 3 m or 2 m or 1.5 m of the longitudinal extent arranged in each case on the end sides of the longitudinal direction) and the elements arranged there are optionally reclassified.
If an obstacle OBT is found in the front or rear end region, other elements in the vicinity (in the region transversely with respect to the obstacle OBT) of said obstacle OBT are reclassified into obstacles OBT. This step deals with the numerous elements which arise due to a complex obstacle OBT, e.g. a driver's cab.
VI. The third step comprises an analysis and optionally a reclassification of the remaining guiding elements GDE and flippers FLP according to the following rules on the basis of the respective relative position:
In the central region of the loading surface of a transport means, elements categorized guiding elements GDE are categorized as flippers FLP. While both guiding elements and flippers FLP are present at the boundary, no guiding elements are located in the central region. Finally, all of the preliminary classifications and the reclassified elements ELM are categorized as definitively classified.

An advantageous development of the invention makes provision for all of the possible positions in which a loading container CNT can be placed onto a transport means TPT or removed therefrom to be determined on the basis of a list of known features of the transport means TPT.

The features may include:
loading containers CNT which have already been loaded on the same transport means TPT,
fastening elements TWL, in particular twistlocks,
guide elements GDE,
flippers FLP,
other obstacles OBT.

Said development of the invention uses three different sub-methods in order to use these features for loading purposes, and then brings together the results of said sub-methods.

The first sub-method partially illustrated in FIG. 30 assesses whether a loading container CNT is already placed on a loading surface LDR of the transport means TPT. If a loading container LDR is already arranged on the transport means TRT, the position of the loading container CNT that is already occupied by a loading container CNT is considered the valid position (the loading container CNT can be unloaded (can be picked) ).

The second sub-method assesses whether fastening elements TWL, in particular twistlocks, are arranged in pairs. In this case, each pair (one on the left side of the transport means TPT, the other on the right side thereof) is compared with every other pair, with a configuration being searched for which has a plausible length for a standard loading container CNT in respect of the distance in the longitudinal direction (longitudinal axis LAX) of the transport means TPT.

The third sub-method which is partially illustrated in FIGS. 31, 32, 33 uses existing guide elements GDE in order to estimate the position and inclination of the loading surface LDR. In this case, a virtual cuboid VQD is positioned in such a manner that, minimally rotated from a horizontal position, it contains all of the guide elements GDE.

Particularly preferably and for efficiency reasons, this position of the cuboid VQD is used as the basis for a new coordinate system (also see above: a transport means coordinate system TCS with a first substantially horizontal transport means coordinate direction TCX along the longitudinal axis LAX of the transport means TPT, with a second substantially horizontal transport means coordinate direction TCY transversely with respect to the first horizontal transport means coordinate direction TCX, and a third substantially vertical transport means coordinate direction TCZ which is perpendicular to the other transport means coordinate directions TCX, TCY), to which, subsequently, all of the assessments, calculations and position details relating to the transport means TPT relate.

In a next step, the minimum rectangle RCT in respect of the horizontal extent and surrounded by the guide elements, fastening elements and other elements on the loading surface is determined.

In a next step, the maximum horizontal rectangle RCT which surrounds the features touching the minimum rectangle RCT is determined.

In a next step, the obstacles OBT are taken into consideration by both the maximum horizontal rectangle RCT and the minimum rectangle RCT being reduced in size to such an extent that obstacles OBT are no longer located in the horizontal region of said two rectangles RCT.

In a next step, the largest standard loading container CNT fitting into the maximum horizontal rectangle RCT in respect of the contact area is determined (comparably to the illustration in FIG. 21).

In a next step, the minimum horizontal rectangle is increased in size in such a way that the largest standard loading container CNT can be surrounded by said rectangle.

Finally, an assessment is also carried out in order to determine the possible positions of the loading container CNT on the loading surface LDR within the adapted minimum rectangle RCT.

These 3 sub-methods are operated in parallel and the corresponding results are combined with one another in the manner of a sum total; since each of the 3 sub-methods returns only the valid positions which have been found, the collation is a simple sum total of the contact areas of the valid positions.

1. A method for detecting a loading surface of a transport device for automated loading with a loading container using a handling device, the method comprising:
defining a spatially fixed coordinate system, a first coordinate direction and a second coordinate direction of which are located substantially in a horizontal plane, and a third coordinate direction of which extends substantially vertically in a height direction;
recording a surface geometry in a region of a handling region, wherein the surface geometry in the region of the handling region is recorded as a point cloud, wherein the handling device has a scanner, by which the handling region is scanned point by point;
identifying a region of the transport device;
determining a location of a loading surface of the transport device;
determining a spatial angular position of a loading surface of the transport device;
identifying and classifying one or more determined loading surfaces of the transport device; and
detecting fastening elements, guide elements, obstacles, loads, or any combination thereof on the loading surface.

2. (canceled)

3. The method of claim 1, wherein identifying the region of the transport device comprises:
entering the point cloud of the surface geometry as an initial point cloud;
defining volumes of the initial point cloud, the volumes in each case extending next to one another in the manner of disks along the first coordinate direction with a certain discretization width with respect to the first coordinate direction;
reducing the initial point cloud by points of a number of outer volumes, such that 30%-80%, 45%-55%, or 50% of an overall width of the volumes remain; and
defining the remaining volumes as a new point cloud.

4. The method of claim 2, wherein identifying the region of the transport device comprises:
defining a range of valid height values for the third coordinate direction of the initial point cloud;
discarding the points in the volumes that exclusively have points with height values outside the range of valid height values; and
defining remaining points as a new point cloud that includes the transport device.

5. The method of claim 2, further comprising:
entering the point cloud of the surface geometry as an initial point cloud;
selecting a horizontal coordinate direction of the first coordinate direction and the second coordinate direction as a profile direction;
defining volumes of the initial point cloud, the volumes in each case extending next to one another in the manner of disks along the other horizontal coordinate direction of the first coordinate direction and the second coordinate direction, not selected, with a certain discretization width with respect to the profile direction;
generating a height profile in the profile direction from profile points, with a profile point being defined for each volume,
wherein a coordinate of the profile point in the profile direction is allocated as a coordinate value of the profile direction in each case to a certain position of the discretization width of the volume,
wherein the determined position for each volume is at the same point of the discretization width, and
wherein the coordinate of the profile point in the height direction is allocated as a coordinate value of the highest value in each case present in the volume of the third coordinate direction of a point.

6. The method of claim 3, wherein the determined discretization width is between 1 cm-1 m, and details of the loading surface are detectable.

7. The method of claim 4, wherein a range of valid height values for the third coordinate direction is between 20 cm and 700 cm.

8. The method of claim 2, further comprising determining ends of the transport device in the first horizontal coordinate direction, the determining of the ends of the transport device in the first horizontal coordinate direction comprising:
entering the point cloud of the surface geometry as an initial point cloud;
defining volumes of the initial point cloud, the volumes in each case extending next to one another in the manner of disks along the second horizontal coordinate direction with a second discretization width of at least 4.572 m or 6.096 m;
carrying out the entering, the selecting, the defining, and the generating for each individual point cloud arranged in each of the volumes, with the following stipulations:
the second horizontal coordinate direction is the profile direction, thus resulting in a height profile extending along the second horizontal coordinate direction; and
the determined discretization width is between 1 cm-1 m;
comparing a widest length of the height profile with respect to the second horizontal coordinate direction with a minimum value and discarding the points located in the respective volume when the widest length lies below the minimum value; and
defining a non-discarded portion of the initial point cloud as a new point cloud that comprises the transport device.

9. The method of claim 8, wherein the first horizontal coordinate direction is the profile direction, thus resulting in the height profile extending along the first horizontal coordinate direction,
wherein the determined discretization width is between 1 cm and 1 m, is between 5 cm-15 cm, or is 10 cm, and
wherein the method further comprises:
dividing the height profile into two-dimensional object profiles, wherein an object profile of the two-dimensional object profiles extends over a region of the first horizontal coordinate direction, which exclusively has profile points with height values of the height profile of greater than 0; and
combining object profiles that are at a distance of less than 3 m or less than 1.5 m from one another in the first horizontal coordinate direction to form in each case a common object profile, and therefore the transport is in each case located in resulting regions of the first horizontal coordinate direction of the common object profiles.

10. The method of claim 5, wherein the first horizontal coordinate direction is the profile direction, thus resulting in a height profile extending along the first horizontal coordinate direction, and
wherein the determined discretization width is between 1 cm-1 m, between 5 cm-15 cm, or is 10 cm, and
wherein the method further comprises:
dividing the height profile into segments, the dividing comprising determining a segment by the stipulation that, in a step-by-step evaluation from point to point, a vertical distance from the previous point is less than 2 horizontal discretization widths; and
defining a longest segment determined in this way as a preliminary estimation of a loading surface extent along the first horizontal coordinate direction.

11. The method of claim 10, further comprising:
defining a vertical offset from a value range of the third vertical coordinate direction of the preliminary estimation of the loading surface extent.

12. The method of claim 10, wherein determining the spatial angular position of the loading surface of the transport device comprises:
carrying out the method for the point cloud exclusively in the region of the preliminary estimation of the loading surface extent,
wherein the first horizontal coordinate direction is the profile direction, thus resulting in a height profile extending along the first horizontal coordinate direction,
wherein the determined discretization width is between 1 cm-1 m, is between 5 cm-15 cm, or is 10 cm,
wherein dividing the height profile into segments comprises determining a segment by the stipulation that, in a step-by-step evaluation from point to point, the vertical distance from the previous point is less than half a horizontal discretization width, and
wherein the method further comprises:
defining the longest segment determined in this; and
determining an angle of inclination of the longest segment determined in this way as an angle of inclination of the loading surface.

13. The method of claim 1, further comprising identifying edges on the determined loading surface of the transport device, the identifying of the edges on the determined loading surface of the transport device comprising:
providing a grid consisting of individual grid elements of the region;
selecting grid elements of the individual grid elements that contain points;
determining grid elements that comprise an edge of the transport device as edge grid elements;
sorting the edge grid elements according to the respective edge orientation based on the spatial coordinate system into groups of edge grid elements containing edge points, wherein the groups comprise falling edge points in the first horizontal coordinate direction, rising edge points in the first horizontal coordinate direction, falling edge points in the second horizontal coordinate direction, and rising edge points in the second horizontal coordinate direction; and
generating edge lines with reference to the edge points by multiple line segmentations for the respective groups, wherein, in the case of the line segmentation, a line is in each case placed through as many predefined surrounding volumes of edge points as possible and the edge points are replaced by the respective line.

14. The method of claim 13, further comprising determining an inclination of edge lines in relation to the first horizontal coordinate direction, the determining of the inclination of the edge lines comprising:
combining edge lines, such that combined edge lines are formed, the edge lines that enclose a same angle in relation to the first horizontal coordinate direction apart from an angle deviation region being combined;
determining a quality factor for the edge lines, the combined edge lines, or the edge lines and the combined edge lines, the quality factor being rising or proportionally rising with a number of edge points replaced by the edge line or the edge lines on which the combined edge line is based;
establishing a longitudinal axis of the transport device, a direction of the edge lines, the combined edge lines, or the edge lines and the combined edge lines that have an angular deviation from the first horizontal coordinate direction that is smaller than 10° and the quality factor of which is highest compared to others being defined as a direction of the longitudinal axis; and
determining a first offset angle between the first horizontal coordinate direction and the longitudinal axis of the transport device.

15. The method of claim 14, further comprising identifying and classifying a determined loading surface of the transport device, the identifying and the classifying of the determined loading surface of the transport device comprising:
based on the spatially fixed coordinate system and using the angle of inclination and the first offset angle, defining a transport device coordinate system with a first substantially horizontal transport device coordinate direction along the longitudinal axis of the transport device, with a second substantially horizontal transport device coordinate direction transversely with respect to the first horizontal transport device coordinate direction, and with a third substantially vertical transport device coordinate direction that is perpendicular to the other transport device coordinate directions;
defining a two-dimensional reference contour corresponding to a contact area of a loading container with respect to the transport device coordinate system;
identifying a level loading surface of the transport device to be loaded;
defining a two-dimensional loading surface contour as a projection in a direction of the third transport device coordinate direction of the level loading surface;
repeating a virtual test to superimpose the two-dimensional reference contour on a reference contour position with the two-dimensional loading surface contour such that certain criteria are met, wherein the certain criteria includes:
no edge of the two-dimensional reference contour is located outside the two-dimensional loading surface contour;
the two-dimensional reference contour is arranged completely in the two-dimensional loading surface contour; and
there is no edge of the two-dimensional loading surface in a region of overlapping of the two-dimensional reference contour with the two-dimensional loading surface contour,
wherein the reference contour positions that meet the certain criteria are classified as valid reference contour positions,
wherein, during each repetition, the two-dimensional reference contour is moved to a different reference contour position with a predefined step width with respect to the two-dimensional loading surface contour in the first transport device coordinate direction, wherein the virtual test is repeated until the two-dimensional reference contour has passed through a test contour along all possible steps in the first transport device coordinate direction,
wherein, during each repetition, the two-dimensional reference contour is moved with a predefined step width with respect to the test contour in the second transport device coordinate direction, wherein the virtual test is repeated until the two-dimensional reference contour has passed through the test contour along all possible steps along the second transport device coordinate direction and until the two-dimensional reference contour has passed through the test contour along all possible steps along the first transport device coordinate direction, and
wherein mutually overlapping reference contours at valid reference contour positions are joined together to form a common valid loading surface.

16. The method of claim 1, wherein the determined loading surface of the transport device is classified as a loaded loading surface when points of the loading surface lie in a vertical coordinate direction in a region of an anticipated height of a loading container roof.

17. The method of claim 1, wherein detecting the fastening elements comprises:
selecting points of the point cloud in a horizontal region of the identified one or more determined loading surfaces that, with respect to a predefined surrounding volume, have a local maximum value of the third coordinate direction as potential fastening element positions;
defining predefined patterns of horizontal arrangements of fastening elements; and
comparing the predefined patterns with the potential fastening element positions to determine a best correspondence,
wherein the potential fastening element positions without a correspondence to an element of a pattern are discarded and the potential fastening element positions with a correspondence are established as fastening element positions.

18. A method for generating instructions for a handling device, in particular a crane, for positioning a loading container on a loading surface of a transport device, the method comprising:
detecting the loading surface of the transport device for automated loading with the loading container, the detecting comprising:
defining a spatially fixed coordinate system, a first coordinate direction and a second coordinate direction of which are located substantially in a horizontal plane, and a third coordinate direction of which extends substantially vertically in a height direction;
recording a surface geometry in a region of a handling region, wherein the surface geometry in the region of the handling region is recorded as a point cloud, wherein the handling device has a scanner, by which the handling region is scanned point by point;
identifying a region of the transport device;
determining a location of a loading surface of the transport device;
determining a spatial angular position of a loading surface of the transport device;
identifying and classifying one or more determined loading surfaces of the transport device; and
detecting fastening elements, guide elements, obstacles, loads, or any combination thereof on the loading surface; and
selecting the loading container that fits a determined loading surface and the associated fastening elements of the transport device.

19. A method for loading a transport device with a loading container, the method comprising:
generating instructions for a handling device, in particular a crane, for positioning the loading container on a loading surface of the transport device, the generating comprising:
detecting the loading surface of the transport device for automated loading with the loading container, the detecting comprising:
defining a spatially fixed coordinate system, a first coordinate direction and a second coordinate direction of which are located substantially in a horizontal plane, and a third coordinate direction of which extends substantially vertically in a height direction;
recording a surface geometry in a region of a handling region, wherein the surface geometry in the region of the handling region is recorded as a point cloud, wherein the handling device has a scanner, by which the handling region is scanned point by point;
identifying a region of the transport device;
determining a location of a loading surface of the transport device;
determining a spatial angular position of a loading surface of the transport device;
identifying and classifying one or more determined loading surfaces of the transport device; and
detecting fastening elements, guide elements, obstacles, loads, or any combination thereof on the loading surface; and
selecting the loading container that fits a determined loading surface and the associated fastening elements of the transport device; and
loading the loading surface of the transport device with the selected loading container.

20. A handling device comprising:
a crane; and
a control unit, by which the crane is controllable,
wherein the control unit comprises at least one processor, and
wherein the handling device comprises at least one handling region for parking a transport device and a loading container region for setting down at least one loading container,
wherein the handling device comprises at least one scanner, by which the handling region is recordable point by point,
wherein the control unit is connected to the at least one scanner, such that the points are transferable in the form of a point cloud from the scanner to the control unit,
wherein the control unit is configured to identify a loading surface of the transport device for automated loading with the at least one loading container using the handling device, the control unit being configured to identify the loading surface of the transport device comprising the control unit being configured to:
define a spatially fixed coordinate system, a first coordinate direction and a second coordinate direction of which are located substantially in a horizontal plane, and a third coordinate direction of which extends substantially vertically in a height direction;
record a surface geometry in a region of a handling region of the at least one handling region, wherein the surface geometry in the region of the handling region is recorded as a point cloud;
identify a region of the transport device;
determine a location of a loading surface of the transport device;
determine a spatial angular position of a loading surface of the transport device;
identify and classify one or more determined loading surfaces of the transport device;
detect fastening elements, guide elements, obstacles, loads, or any combination thereof on the loading surface; and
control the crane with reference to the determined spatial angular position such that a loading container of the at least one loading container is positionable from the loading container region onto the loading surface to be loaded.
